(19) United States
(12) Patent Application Publication
(10) Pub. No.: US 2009/0212511 A1
(43) Pub. Date: Aug. 27, 2009

(54) SKATE WITH ANTI-TIPPING BRACKET FOR USE WITH FLOOR TRACK STORAGE SYSTEM

(75) Inventors: Paul Northam, Corinth, TX (US); Eric Yocum, Dover, DE (US); William L. Bartz, JR., Dover, DE (US)

Correspondence Address: CONNOLLY BOVE LODGE & HUTZ, LLP, P O BOX 2207, WILMINGTON, DE, 19899, US

(73) Assignee: METAL MASTERS FOODSERVICE EQUIPMENT CO., INC., Clayton, DE (US)

(21) Appl. No.: 12/034,781

(22) Filed: Feb. 21, 2008

(51) Int. Cl. B60G 25/00

(52) U.S. Cl. 280/6.154

(57) ABSTRACT

A skate for a storage device for use with a floor track system comprises an elongate inverted U-shaped channel member having front and rear end portions. Front and rear wheels within the channel member are journaled thereto for rotation along the rails of the floor track system. A storage device is mounted on a pair of parallel skates for movement along the rails. An anti-tipping bracket is secured to the channel member, and the anti-tipping bracket includes a framework outwardly extending from the front end portion of the channel member to prevent forward tipping of the storage device by engaging forward support structure.

### BACKGROUND OF THE INVENTION

The present invention is directed to a wheeled skate for use with a floor track storage system, and more particularly to a skate that includes an outwardly extending anti-tipping bracket that prevents the storage system from tipping forward.

Floor track storage systems are well known in the art, and generally they include a pair of parallel V-shaped rails mounted to the floor. Storage devices such as posts and shelving, cabinets, racks and the like are mounted on wheels which are guided on the rails. The wheels are fixed against swiveling movement so that the storage device only moves in a linear direction. Such systems allow for more efficient use of floor space, and for increased storage space in offices, hospitals, food service environments and the like.

U.S. Pat. No. 6,681,702 granted Jan. 27, 2004, discloses a skate for use with a floor track storage system, and this patent is incorporated herein by reference for all intents and purposes. This patent shows a skate having wheels which ride on rails, and a storage device of one type or another is secured to a pair of skates that ride on parallel rails. Often there is a tendency of the storage device to inadvertently tip forward particularly when the underlying skates come to a stop at the end of the rails, and such an occurrence is certainly potentially dangerous. Tipping may occur due to uneven floors or due to unevenly distributed weight of shelf contents.

### SUMMARY OF THE INVENTION

Accordingly, a real need exists for a skate that is easy to use in a safe manner with a variety of storage devices so that such a device may be used on a floor track system with a minimum of effort by the user in a safe manner that prevents dangerous tipping of the storage device.

The present invention is constructed and arranged to overcome the deficiencies of the prior art discussed above. It is an object of the present invention to provide a wheeled skate that is simple to assemble and which fits under a wide variety of standard storage devices and which contains an anti-tipping bracket that prevents the storage device from tipping forward.

It is another object of the present invention to provide a skate with an anti-tipping bracket that can be used with a conventional floor track storage system.

In accordance with the present invention, a skate for a storage device for use with a floor track comprises an elongate inverted U-shaped channel member having front and rear end portions. Front and rear wheels within the channel member are journaled thereto for rotation along the rails of a floor track system. The channel member is connected to a storage device that rides on the floor track system. Significantly, an anti-tipping bracket is secured to the skate, and the bracket includes a framework outwardly extending from the front end of the skate. The bracket is constructed and arranged to prevent forward tipping of the storage device by engaging forward support structure such as the floor or the forward stop traditionally positioned at the forward end of the rails.

The storage device may include upright support posts connected to the skate with horizontal shelving connected between the posts.

Preferably, the anti-tipping bracket has a horizontal plate and down turned sides that fit over the inverted U-shaped channel. Moreover, the inverted U-shaped channel may include openings at the front and rear end portions, and the horizontal plate of the anti-tipping bracket may include an opening in alignment with the front opening in the inverted U-shaped channel member. Mounting bolts may extend through the opening from within the inverted U-shaped member into the storage device thereby uniting the various components together.

### BRIEF DESCRIPTION OF THE DRAWINGS

Novel features and advantages of the present invention in addition to those mentioned above will become apparent to persons of ordinary skill in the art from a reading of the following detailed description in conjunction with the accompanying drawings wherein similar reference characters refer to similar parts and in which:

FIG. 1 is a side elevational view of a floor track storage system that includes a load bearing wheeled skate with an anti-tipping bracket secured thereto, according to the present invention;

FIG. 2 is a side elevational view similar to FIG. 1, but illustrating the anti-tipping bracket preventing forward tipping of the load bearing wheeled skate;

FIG. 3 is an exploded perspective view illustrating the load bearing skate and the anti-tipping bracket as connected to the skate;

FIG. 4 is a front elevational view of the anti-tipping bracket, according to the present invention;

FIG. 5 is a right side elevational view of the anti-tipping bracket; and

FIG. 6 is a top plan view of the anti-tipping bracket.

### DETAILED DESCRIPTION OF THE INVENTION

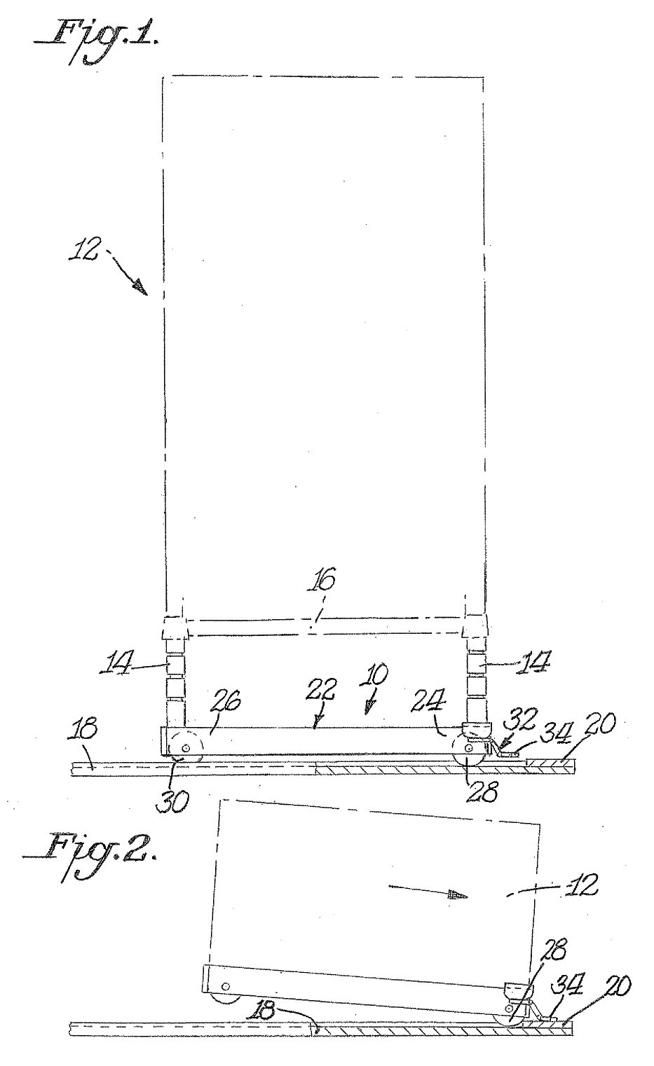

Referring in more particularity to the drawings, FIGS. 1 and 2 show a wheeled device in the form of a wheeled skate 10 constructed in accordance with the principles of the present invention. The wheeled skate 10 is connected to the bottom of a storage device 12 such as upright posts 14 and a plurality of shelves 16 connected to the posts. The storage device may also be in the form of cabinets, racks and other devices. Normally two wheeled skates 10 parallel to one another are mounted to the underside of the storage device, and the skates ride within a conventional floor track system that includes a pair of spaced apart parallel rails 18, one of which is shown in FIGS. 1 and 2. The front end of each rail 18 includes a stop 20 at the forward end thereof to prevent further forward movement of the storage device on the floor track system.

Each wheeled skate 10 comprises an inverted U-shaped channel member 22 having front and rear end portions 24, 26, respectively. Front and rear wheels 28, 30, respectively, are positioned within the channel member 22, and the wheels are journaled to the channel member at the front and rear end portions thereof for rotation along the rails 18.

Significantly, an anti-tipping bracket 32 is secured to the channel member 22 at the front end portion 24. The anti-tipping bracket includes a downwardly and outwardly extending framework 34 extending forward from the front end portion 24 of the channel member. The anti-tipping bracket 32 prevents forward tipping of the storage device 12 by engaging forward support structure such as the stop 20 at the forward end of each rail 18. Alternatively the anti-tipping bracket and particularly the framework 34 may be designed to simply engage the floor upon which the rails are mounted.

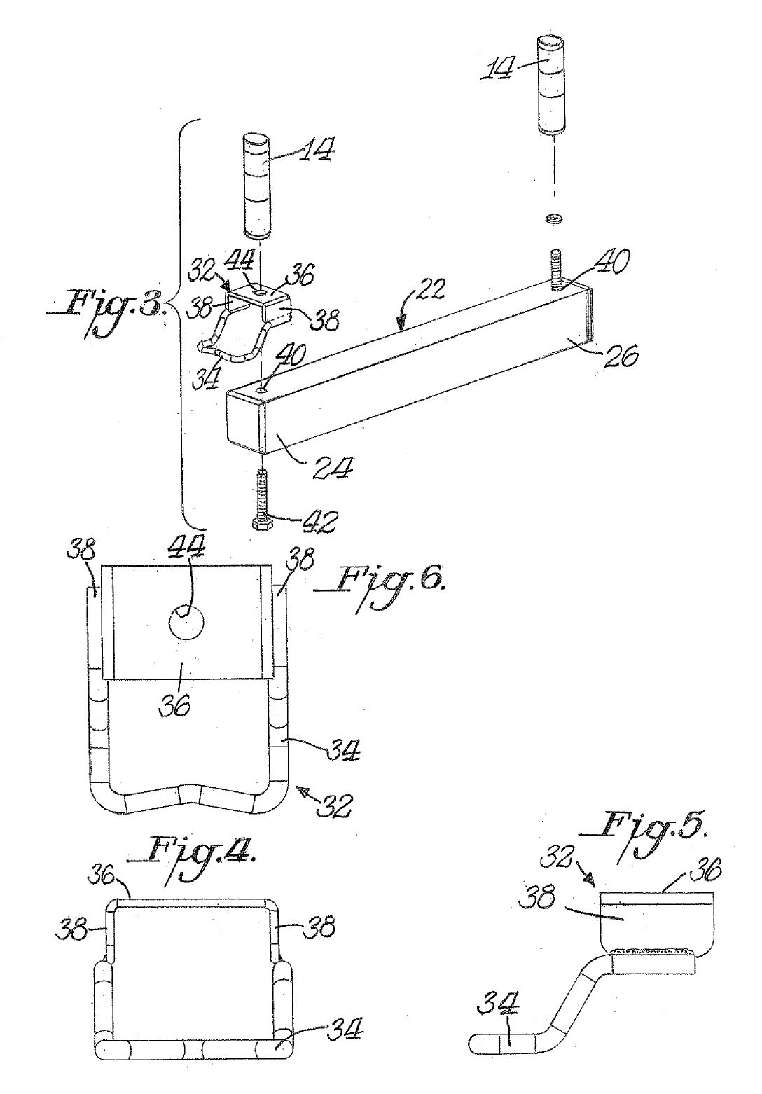

As shown best in FIGS. 3-6, the anti-tipping bracket 32 also includes a horizontal top plate 36 and down turned sides 38 that fit over the inverted U-shaped channel member 22. Front and rear openings 40 in the front and rear end portions of the channel member 22 are adapted to receive bolt like fasteners 42 from within the inverted U-shaped channel member and into threaded openings in the upright posts 14 in order to secure the skate 10 to the storage device 12. Additionally, the top horizontal plate 36 of the anti-tipping bracket 32 has an opening 44 which is in alignment with the opening 40 in the front end portion of the channel member 22. Hence, when the bolt fastener 32 extends through the front opening 40 and then through the opening 44 in the top horizontal plate 36 and into the front upright post 14, the anti-tipping bracket 32 is securely sandwiched between the channel member 22 and the upright post 14.

In operation, a pair of wheeled skates 10 parallel to each other, one secured to the underside of the storage device 12. The front end rear wheels 28, 30 ride in a linear direction on the parallel rails 18 of the floor track system. The wheels 28, 30 ride along the rails 18 between a rear position and a forward position defined by the stop 20 at the forward end of each rail. When the forward wheel 28 engages the stop 20 the storage device 12 comes to a rest and remains at this position until the storage device is pushed in a backward direction. When the front wheel 28 initially engages the stop 20 there is a tendency of the storage device 12 to tip in a forward direction, as illustrated in FIG. 2. Such tendency depends upon the load of the storage device and the speed of travel of the device along the rails 18. If forward tipping does occur the downwardly and outwardly extending framework 34 of the anti-tipping bracket 32 engages the stop 20, as shown best in FIG. 2, to thereby prevent complete forward tipping of the storage device 12.

Uneven floors may also cause or increase the tendency of tipping, and the brackets 32 alleviate such tendency. Also, unevenly distributed weight of the contents of the storage device may also contribute to possible tipping which is alleviated by the anti-tipping bracket.

Throughout movement of the storage device along the rails of the track system the brackets hover over the tracks, but do not make contact with the tracks or supporting floor unless the storage device begins to tip over.

We claim:

1. A skate for a storage device for use with a floor track system comprising:
an elongate inverted U-shaped channel member having front and rear end portions;
front and rear wheels within the channel member journaled thereto for rotation;
means for attaching the channel member to a storage device; and
an anti-tipping bracket secured to the channel member including a framework outwardly extending from the front end portion of the channel member constructed and arranged to prevent forward tipping of the storage device by engaging forward support structure.

2. A skate as in claim 1 wherein the storage device comprises upright posts connected to the channel member with shelving connected to the posts.

3. A skate as in claim 1 wherein the anti-tipping bracket includes a horizontal plate and down turned sides that fit over the inverted U-shaped channel member.

4. A skate as in claim 1 wherein the inverted U-shaped channel includes openings at the front and rear end portions thereof and the horizontal plate of the anti-tipping bracket includes an opening in alignment with the front opening in the channel member, and fastening means extending through the front opening in the channel member and the opening in the horizontal plate in the anti-tipping bracket and into the storage device.
